(19) United States
(12) Patent Application Publication
(10) Pub. No.: US 2009/0098474 A1
(43) Pub. Date: Apr. 16, 2009

(54) ELECTROPHOTOGRAPHIC PHOTORECEPTOR CONTAINING NAPHTHALENETETRACARBOXYLIC ACID DIIMIDE DERIVATIVES AS ELECTRON TRANSPORT MATERIALS IN A CHARGE TRANSPORTING LAYER AND ELECTROPHOTOGRAPHIC IMAGING APPARATUS INCLUDING THE SAME

(75) Inventors: Beom-jun KIM, Yongin-si (KR); Ji-uk KIM, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/125,216

(22) Filed: May 22, 2008

(30) Foreign Application Priority Data
Oct. 15, 2007 (KR) 2007-103722

(51) Int. Cl. G03G 15/02

(52) U.S. Cl. 430/58.5

(57) ABSTRACT

A laminated type electrophotographic photoreceptor including an electrically conductive substrate and a charge generating layer and a charge transporting layer disposed on the electrically conductive substrate, wherein the charge transporting layer includes a naphthalenetetracarboxylic acid diimide derivative represented by Formula 1 below, and an electrophotographic imaging apparatus including the electrophotographic photoreceptor

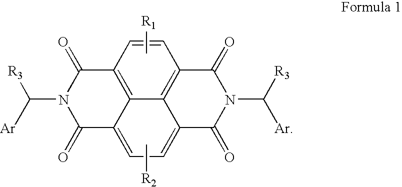

### CROSS-REFERENCE TO RELATED APPLICATIONS

This application claims the priority from Korean Patent Application No. 10-2007-0103722, filed on Oct. 15, 2007, in the Korean Intellectual Property Office, the disclosure of which is incorporated herein in its entirety by reference.

### BACKGROUND OF THE INVENTION

1. Field of the Invention

The present general inventive concept relates to an electrophotographic photoreceptor and an electrophotographic imaging apparatus including the same, and more particularly, to an electrophotographic photoreceptor which includes a naphthalenetetracarboxylic acid diimide derivative as an electron transporting material in a charge transporting layer to enhance electrostatic properties such as high photosensitivity and low residual potential in spite of repeated use and an electrophotographic imaging apparatus including the same.

2. Description of the Related Art

In electrophotography devices such as facsimile machines, laser printers, photocopiers, cathode ray tube (CRT) printers, light emitting diode (LED) printers and liquid crystal printers, an electrophotographic photoreceptor includes a photosensitive layer formed on an electrically conductive substrate. The electrophotographic photoreceptor can have the form of a plate, a disk, a sheet, a belt, a drum, or the like. First, a surface of the photosensitive layer is uniformly electrostatically charged, and then the charged surface is exposed to a pattern of light, which thereby forms an image. The light exposure selectively dissipates the charge in the exposed regions where the light strikes the electrostatically charged surface, thereby forming a pattern of charged and uncharged regions, which is referred to as a latent image. Then, a wet or dry toner is applied in the vicinity of the latent image, and toner droplets or particles adhere to either the charged or uncharged regions to form a toner image on the surface of the photosensitive layer. The resulting toner image can then be transferred and fixed to a suitable ultimate or intermediate receiving surface such as paper, or the photosensitive layer itself can function as the ultimate receptor for receiving the toner image.

Electrophotographic photoreceptors are generally categorized into two types. The first type is a laminated electrophotographic photoreceptor having a two-layered structure including a charge generating layer having a binder resin and a charge generating material (CGM), and a charge transporting layer (CTL) having a binder resin and a charge transporting material (mainly, a hole transporting material (HTM)). In general, the laminated type electrophotographic photoreceptor is used in the fabrication of a negative (−) type electrophotographic photoreceptor. The second type is a single layered electrophotographic photoreceptor in which a binder resin, a CGM, an HTM, and an electron transporting material (ETM) are contained in a single layer. In general, the single layered type photoreceptor is used in the fabrication of a positive (+) type electrophotographic photoreceptor.

Recently, although the printing speed of electrophotographic imaging apparatuses such as laser printers and photocopiers has increased, further increase of the printing speed is required. Accordingly, the electrophotographic photoreceptors should have a high sensitivity. In addition, since a diameter of electrophotographic photoreceptor drums decreases with the minimization of electrophotographic imaging apparatuses, the sensitivity of the photoreceptor needs to be improved yet further in order to meet the high speed requirements.

However, when the laminated type electrophotographic photoreceptors are repeatedly used, holes generated in a charge generating layer by the light exposure tend not to be able to be transferred onto the surface of a charge transporting layer and remain in the charge transporting layer, thereby forming a charge (hole) trap. When the charge trap is formed in the charge transporting layer, the sensitivity of the photoreceptor may decrease and a residual potential may increase. The formed charge trap may therefore hinder the electrophotographic imaging apparatus from printing a high quality image with a high speed.

To address these problems, a laminated type electrophotographic photoreceptor including a naphthalenetetracarboxylic acid diimide derivative, represented by the formula below, and a hole transporting material in a charge transporting layer have been previously disclosed in Japanese Patent Publication No. 2005-49470.

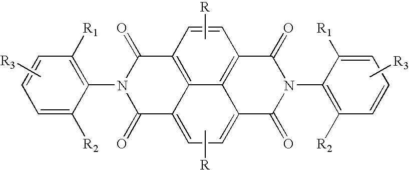

Here, R is a hydrogen atom, an alkyl group or an alkoxy group, and R₁ and R₂ are each independently a substituted or unsubstituted alkyl group, alkoxy group or aryl group which are different from each other, and R₃ is a hydrogen atom, or a substituted or unsubstituted alkyl group, alkoxy group or aryl group.

A laminated type electrophotographic photoreceptor including a naphthalenetetracarboxylic acid diimide derivative represented by the formula below in a charge transporting layer has been previously disclosed in Japanese Patent Publication No. 2004-262813.

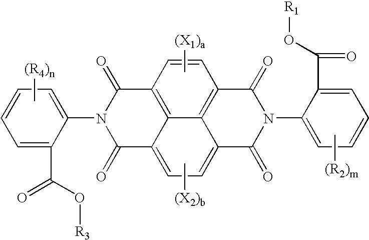

Here, R₁ to R₄ may be the same or different from each other, and are each an alkyl group, a cycloalkyl group, an aryl group or an aralkyl group which may contain a substituent group, and m and n are each the same or different than each other and are each an integer between 0-4. X₁ and X₂ may be the same or different from each other, and are each an alkyl group, an alkoxy group, an acyl group, an acyloxy group, an alkoxycarbonyl group, a cyano group, a nitrogen group, a halogen group, or the like, wherein the groups other than the cyano group, the nitro group and the halogen group may contain a substituent group, and a and b are the same or different than each other and are each an integer between 0-2.

However, since the naphthalenetetracarboxylic acid diimide derivatives disclosed above have symmetrical structures, the derivatives do not have sufficient solubility in an organic solvent or compatibility with a binder. Thus, the naphthalenetetracarboxylic acid diimide derivatives may be crystallized in the photosensitive layer and the photosensitivity of the electrophotographic photoreceptor may therefore decrease.

### SUMMARY OF THE INVENTION

The present general inventive concept provides an electrophotographic photoreceptor having high photosensitivity and low residual potential properties in spite of repeated use by including a naphthalenetetracarboxylic acid diimide derivative.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a laminated type electrophotographic photoreceptor including an electrically conductive substrate, and a charge generating layer and a charge transporting layer disposed on the electrically conductive substrate, wherein the charge transporting layer includes a naphthalenetetracarboxylic acid diimide derivative represented by Formula 1 below:

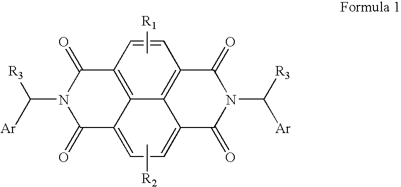

wherein R1 and R2 are each independently a hydrogen atom, a halogen atom, a C1-C20 substituted or unsubstituted alkyl group, or a C1-C20 substituted or unsubstituted alkoxy group, R3 is a C1-C20 substituted or unsubstituted alkyl group, a C1-C20 substituted or unsubstituted alkoxy group, a C7-C30 substituted or unsubstituted aralkyl group, or a —(CH2)n-Y—R4 group, wherein Y is an oxygen atom, a sulfur atom, or NH, R4 is a hydrogen atom, or a C1-C20 substituted or unsubstituted alkyl group, and n is an integer from 1 to 12 and Ar is a C6-C30 substituted or unsubstituted aryl group.

R₁ and R₂ may include hydrogen atoms, R₃ may be methyl, ethyl, propyl, butyl, pentyl, benzyl, or methylbenzyl, and Ar may be phenyl, nitrophenyl, hydroxyphenyl, halophenyl, methoxyphenyl, methylphenyl, naphthyl, anthracenyl, or phenanthrenyl.

The charge transporting layer may further include an arylamine-based compound as a hole transporting material.

The naphthalenetetracarboxylic acid diimide derivative comprised in the charge transporting layer may form a charge transfer complex with a hole transporting material and may absorb long wavelength light at about 600 to about 780 nm to generate charges in the charge transporting layer.

The naphthalenetetracarboxylic acid diimide derivative may be represented by the formula below:

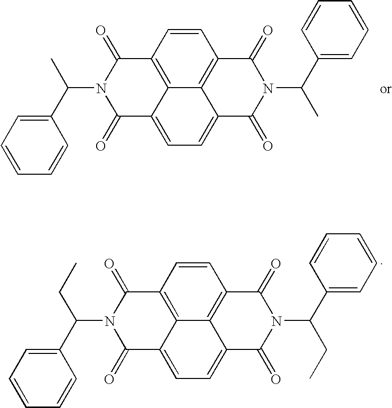

The electrically conductive substrate may include a metal, an electrically conductive polymer or a combination thereof.

The metal may be selected from aluminum, vanadium, nickel, copper, zinc, palladium, indium, tin, platinum, stainless steel, chrome, or a combination thereof.

The electrically conductive polymer may be a material selected from a polyester resin, a polycarbonate resin, a polyamide resin, a polyimide resin, a combination thereof and a copolymer of monomers.

An undercoat may be disposed between the electrically conductive substrate and the charge generating layer or between the electrically conductive substrate and the charge transporting layer.

The undercoat may include at least a conductive powder dispersed in a binder resin or an anodized layer of Al.

The conductive powder may include a carbon black, a graphite, a metal powder, a metal oxide powder, or a combination thereof.

The metal oxide powder may include indium oxide, tin oxide, indium tin oxide, or titanium oxide.

The foregoing and/or other aspects and utilities of the present general inventive concept may be achieved by providing an electrophotographic imaging apparatus including an electrophotographic photoreceptor including an electrically conductive substrate, and a charge generating layer and a charge transporting layer disposed on the electrically conductive substrate, wherein the charge transporting layer includes a naphthalenetetracarboxylic acid diimide derivative represented by Formula 1 below:

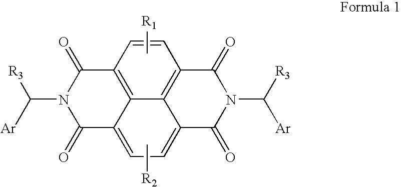

wherein R₁ and R₂ are each independently a hydrogen atom, a halogen atom, a C1-C20 substituted or unsubstituted alkyl group, or a C1-C20 substituted or unsubstituted alkoxy group, R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12, and Ar is a C6-C30 substituted or unsubstituted aryl group.

R₁ and R₂ may include hydrogen atoms, R₃ may be methyl, ethyl, propyl, butyl, pentyl, benzyl, or methylbenzyl, and Ar may be phenyl, nitrophenyl, hydroxyphenyl, halophenyl, methoxyphenyl, methylphenyl, naphthyl, anthracenyl, or phenanthrenyl.

The charge transporting layer may further include an arylamine-based compound as a hole transporting material.

The naphthalenetetracarboxylic acid diimide derivative in the charge transporting layer may form a charge transfer complex with a hole transporting material and may absorb long wavelength light of about 600 to about 780 nm to generate charges in the charge transporting layer.

The long wavelength light may be derived from exposure light or erasure light.

The naphthalenetetracarboxylic acid diimide derivative may be represented by the formula below:

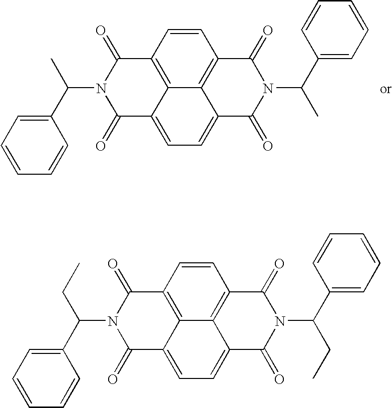

The foregoing and/or other aspects and utilities of the present general inventive concept may be achieved by providing an electrophotographic photoreceptor including an electrically conductive substrate and a photosensitive layer disposed on the electrically conductive substrate, wherein the photosensitive layer includes a naphthalenetetracarboxylic acid diimide derivative represented by Formula 1 below:

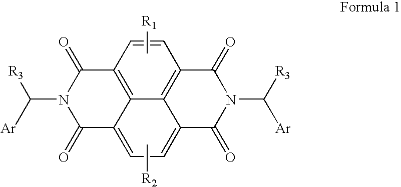

wherein R₁ and R₂ are each independently a hydrogen atom, a halogen atom, a C1-C20 substituted or unsubstituted alkyl group, or a C1-C20 substituted or unsubstituted alkoxy group, R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12, and Ar is a C6-C30 substituted or unsubstituted aryl group.

The foregoing and/or other aspects and utilities of the present general inventive concept may be achieved by providing an electrophotographic imaging apparatus including an electrophotographic photoreceptor including an electrically conductive substrate and a photosensitive layer, wherein the photosensitive layer includes a naphthalenetetracarboxylic acid diimide derivative represented by Formula 1 below:

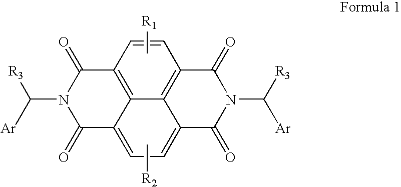

wherein R₁ and R₂ are each independently a hydrogen atom, a halogen atom, a C1-C20 substituted or unsubstituted alkyl group, or a C1-C20 substituted or unsubstituted alkoxy group, R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12, and Ar is a C6-C30 substituted or unsubstituted aryl group.

In the electrophotographic photoreceptor according to the present general inventive concept, the naphthalenetetracarboxylic acid diimide electron transporting material represented by Formula 1 included in the charge transporting layer may form a charge transfer complex with a hole transporting material. The charge transfer complex may absorb light of a long wavelength band ranging from 600 to 780 nm. Thus, the electrophotographic photoreceptor according to the present general inventive concept may absorb exposure light (780 nm) emitted from a laser scanning unit that is used as an exposure device of an electrophotographic imaging apparatus or erasure light (600 nm) emitted from an eraser to generate charges in the charge transporting layer. The generated charges may remove a charge trap formed in the charge transporting layer. As a result, the laminated type electrophotographic photoreceptor according to the present general inventive concept can have excellent electrostatic properties such as high photosensitivity and low residual potential in spite of repeated use.

### BRIEF DESCRIPTION OF THE DRAWINGS

The above and/or other aspects, features and advantages of the present general inventive concept will become apparent and more readily appreciated from the following description of the exemplary embodiments thereof with reference to the accompanying drawing, in which:

FIG. 1 is a perspective view illustrating an electrophotographic imaging apparatus according to an exemplary embodiment of the present general inventive concept.

### DETAILED DESCRIPTION OF THE PREFERRED EMBODIMENTS

Hereinafter, an electrophotographic photoreceptor and an electrophotographic imaging apparatus including the same according to the present general inventive concept will now be described more fully with reference to the accompanying drawing, in which exemplary embodiments of the invention are illustrated.

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The electrophotographic photoreceptor according to the present general inventive concept has a laminated structure in which a charge generating layer and a charge transporting layer are sequentially formed on a conductive substrate, wherein the charge generating layer and the charge transporting layer together constitute a photosensitive layer. However, the present general inventive concept is not limited thereto, and the formation sequence of the charge transporting layer and the charge generating layer can be reversed, for example.

The electrically conductive substrate may be in the form of a drum, pipe, belt, plate or the like which may include any conductive material, for example, a metal, or an electrically conductive polymer, combinations thereof or the like. The metal may be aluminum, vanadium, nickel, copper, zinc, palladium, indium, tin, platinum, stainless steel, chrome, combinations thereof, or the like. The electrically conductive polymer may be a polyester resin, polycarbonate resin, a polyamide resin, a polyimide resin, mixtures thereof, or a copolymer of monomers used in preparing the resins described above in which an electrically conductive material such as a conductive carbon, tin oxide, indium oxide, or the like is dispersed. An organic polymer sheet on which a metal is deposited or a metal sheet is laminated may be used as the electrically conductive substrate.

An undercoat layer may further be formed between the conductive substrate and the photosensitive layer in order to prevent charge injection to the photosensitive layer from the conductive substrate and/or to improve adhesion therebetween.

The undercoat layer may be formed by dispersing a conductive powder such as carbon black, graphite, metal powder, or a metal oxide powder such as indium oxide, tin oxide, indium tin oxide, or titanium oxide in a binder resin such as polyamide, polyvinylalcohol, casein, ethylcellulose, gelatin, a phenol resin, or the like. The undercoat layer in this form may have a thickness of about 5 μm to about 50 μm. The undercoat layer may also be an anodized layer of Al. A thickness of the anodized layer of Al may be in the range of from about 0.05 μm to about 5 μm. The undercoat layer may include both the layer formed by dispersing a conductive power in a binder resin and the anodized layer of Al.

The photosensitive layer including the charge generating layer and the charge transporting layer is formed on the conductive substrate of the laminated electrophotographic photoreceptor according to the present general inventive concept.

A charge generating material used to form the charge generating layer may be an organic pigment or an inorganic pigment. If an organic pigment is used as the charge generating material, electrical properties of the electrophotographic photoreceptor can be easily adjusted and various crystalline structures can be obtained depending on synthesis methods and processing conditions. Thus, in an exemplary embodiment, the use of an organic pigment is desired. Examples of the charge generating material may include a phthalocyanine-based pigment, an azo-based compound, a bisazo-based compound, a triazo-based compound, a quinone-based pigment, a perylene-based compound, an indigo-based compound, a bisbenzoimidazole-based pigment, an anthraquinone-based compound, a quinacridone-based compound, an azulenium-based compound, a squarylium-based compound, a pyrylium-based compound, a triarylmethane-based compound, a cyanine-based compound, a perynone-based compound, a polycycloquinone-based compound, a pyrrolopyrrole-based compound, a naphthalocyanine-based compound, and the like, but the present invention is not limited thereto. The charge generating materials can be used alone or in combination of two or more of the above materials. In an exemplary embodiment, the charge generating material may be a phthalocyanine-based pigment. Examples of the phthalocyanine-based pigment may include a titanyloxy phthalocyanine pigment such as D-type or Y-type titanyloxy phthalocyanine having a strongest diffraction peak at a Bragg angle of about 27.1° (2θ±0.2°), a β-type titanyloxy phthalocyanine having a strongest diffraction peak at a Bragg angle of about 26.1° (2θ±0.2°), an α-type titanyloxy phthalocyanine having a strongest diffraction peak at a Bragg angle of about 7.5° (2θ±0.2°), or the like, in a powder X-ray diffraction peak; or a metal-free phthalocyanine pigment such as X-type metal-free phthalocyanine or T-type metal-free phthalocyanine having a strongest diffraction peak at Bragg angles of about 7.5° and about 9.2° (2θ±0.2°) in a powder X-ray diffraction peak. Phthalocyanine-based pigments have the highest sensitivity to light at a wavelength in the range of about 780-800 nm and the sensitivity being able to be adjusted to some extent dependent on the crystalline structure of the pigments, and thus can be effectively used in the present general inventive concept.

The charge generating material used in the charge generating layer is dispersed in a binder resin. The binder resin may include polyvinylbutyral, polyvinylacetal, polyester, polyamide, polyvinylalcohol, polyvinylacetate, polyvinylchloride, polyurethane, polycarbonate, polymethylmethacrylate, polyvinylidenechloride, polystyrene, styrene-butadiene copolymer, styrene-methyl methacrylate copolymer, vinylidenechloride-acrylonitrile copolymer, vinylchloride-vinylacetate copolymer, vinylchloride-vinylacetate-maleic anhydride copolymer, ethylene-acrylic acid copolymer, ethylene-vinylacetate copolymer, methylcellulose, ethylcellulose, nitrocellulose, carboxymethyl cellulose, polysilicone, a silicone-alkid resin, a phenol-formaldehyde resin, a cresol-formaldehyde resin, a phenoxy resin, a styrene-alkid resin, a poly-N-vinylcarbazole resin, polyvinylformal, polyhydroxystyrene, polynorbornene, polycycloolefines, polyvinylpyrroidone, poly(2-ethyl-oxazoline), polysulfone, a melamin resin, an urea resin, an amino resin, an isocyanate resin, an epoxy resin, or the like, but the present general inventive concept is not limited thereto. The binder resin can be used alone or in combination of two or more of the above materials.

An amount of the binder resin may be in the range of from about 5 to about 350 parts by weight, and more preferably in the range of from about 10 to about 200 parts by weight, based on 100 parts by weight of the charge generating material. If the amount of the binder resin is less than 5 parts by weight based on 100 parts by weight of the charge generating material, the charge generating material is not fully dispersed and thus the obtained dispersion solution is less stable. Therefore, when the dispersion solution is coated on the electrically conductive substrate, a uniform charge generating layer cannot be obtained, and also, an adhesive force between the charge generating layer and the electrically conductive substrate can be reduced. However, if the amount of the binder resin is greater than 350 parts by weight based on 100 parts by weight of the charge generating material, a charging potential cannot be maintained and the photosensitivity of the charge generating layer is low due to an excessive amount of the binder resin, and thus a desired image cannot be obtained.

A solvent used in preparing a coating composition for forming a charge generating layer can vary according to the type of the binder resin used and, preferably, should not have an adverse effect on an adjacent layer when forming the charge generating layer. Specific examples of the solvent may include methyl isopropyl ketone, methyl isobutyl ketone, 4-methoxy-4-methyl-2-pentanone, isopropyl acetate, t-butyl acetate, isopropyl alcohol, isobutyl alcohol, acetone, methylethyl ketone, cyclohexanone, 1,2-dichloroethane, 1,1,2-trichloroethane, 1,1,1-trichloroethane, trichloroethylene, tetrachloroethane, dichloromethane, tetrahydrofuran, dioxane, dioxolane, methanol, ethanol, 1-propanol, 1-butanol, 2-butanol, 1-methoxy-2-propanol, ethyl acetate, butyl acetate, dimethyl sulfoxide, methylcellosolve, butyl amine, diethyl amine, ethylene diamine, isopropanol amine, triethanol amine, triethylene diamine, N,N′-dimethyl formamide, 1,2-dimethoxyethane, benzene, toluene, xylene, methylbenzene, ethylbenzene, cyclohexane, anisole, and the like. However, the present general inventive concept is not limited thereto. These solvents may be used alone or in combination of two or more of the above solvents.

Next, the method of preparing the coating composition for forming the charge generating layer will be described. First, 100 parts by weight of a charge generating material such as a phthalocyanine pigment and 5 to 350 parts by weight, more preferably 10 to 200 parts by weight of a binder resin are mixed with an appropriate amount of a solvent, for example, 100 to 10,000 parts by weight, preferably 500 to 8,000 parts by weight. Glass beads, steel beads, zirconia beads, alumina beads, zirconia balls, alumina balls, or steel balls are added to the mixture and the resulting mixture are dispersed using a dispersing apparatus for about 2 to 50 hours. The dispersing apparatus used herein may be, for example, an attritor, a ball-mill, a sand-mill, a banburry mixer, a roll-mill, three-roll mill, nanomiser, microfluidizer, a stamp mill, a planetary mill, a vibration mill, a kneader, a homonizer, a Dyno-Mill, a micronizer, a paint shaker, a high-speed agitator, an ultimiser, an ultrasonic homogenizer, or the like. The above dispersing apparatuses may be used alone or in combination of two or more of the above dispersing apparatuses.

The coating composition for forming the charge generating layer is coated on the above-described electrically conductive substrate using a coating method such as a dip coating method, a ring coating method, a roll coating method, a spray coating method, or the like. The coated electrically conductive substrate is dried at about 90 to about 200° C. for about 0.1 to 2 hours, thereby forming the charge generating layer.

The thickness of the charge generating layer may be 0.001 to 10 μm, preferably 0.01 to 10 μm, and more preferably 0.05 to 3 μm. When the thickness of the charge generating layer is less than 0.001 μm, it is difficult to form the charge generating layer to have a uniform thickness. When the thickness of the charge generating layer is greater than 10 μm, electrophotographic characteristics tend to be degraded.

Subsequently, in a case of the charge transporting layer including a hole transporting material, the naphthalenetetracarboxylic acid diimide electron transporting material represented by Formula 1 and a binder resin is laminated on the charge generating layer.

Examples of the hole transporting material that may be used herein include nitrogen containing cyclic compounds or condensed polycyclic compounds such as a hydrazone-based compound, a butadiene-based amine compound, benzidine-based compounds including N,N′-bis-(3-methylphenyl)-N,N′-bis(phenyl)benzidine, N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine, a pyrene-based compound, a carbazole-based compound, an arylmethane-based compound, a thiazol-based compound, a styryl-based compound, a pyrazolin-based compound, an arylamine-based compound, an oxazole-based compound, an oxadiazole-based compound, a pyrazolone-based compound, a stilbene-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, and a formaldehyde-based condensed resin. Also, in exemplary embodiments, a high molecular weight compound having substituents of the above compounds in a backbone or a side chain may be used.

The hole transporting material may be an arylamine-based compound in order to easily form a charge transfer complex with the naphthalenetetracarboxylic acid diimide electron transporting material represented by Formula 1.

In exemplary embodiments, the charge transporting layer may further include the naphthalenetetracarboxylic acid diimide electron transporting material represented by Formula 1 in addition to the hole transporting material:

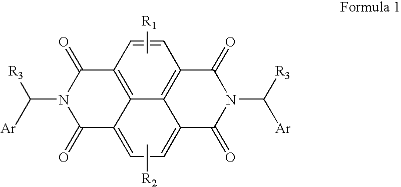

wherein, R₁ and R₂ are each independently a hydrogen atom, a halogen atom, a C1-C20 substituted or unsubstituted alkyl group, or a C1-C20 substituted or unsubstituted alkoxy group,

R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12 and Ar is a C6-C30 substituted or unsubstituted aryl group.

The naphthalenetetracarboxylic acid diimide derivative represented by Formula 1 includes a branched alkyl group in which an aryl group is substituted to a carbon atom located at an a position with respect to the nitrogen atom of the imide bond. The naphthalenetetracarboxylic acid diimide derivative was used in a positive (+) type single layered electrophotographic photoreceptor disclosed in a pending Korean Patent Application No. 2004-0024503 and in a negative (−) type laminated electrophotographic photoreceptor disclosed in a pending Korean Patent Application No. 2005-0050495. A method of preparing the naphthalenetetracarboxylic acid diimide derivative is disclosed in Korean Patent Application No. 2004-0024503 in detail. The disclosures of Korean Patent Application No. 2004-0024503 and Korean Patent Application No. 2005-0050495 are herein incorporated in their entireties by reference.

The naphthalenetetracarboxylic acid diimide electron transporting material represented by Formula 1 included in the charge transporting layer may form a charge transfer complex with a hole transporting material. The charge transfer complex is a molecular complex generated by exchanging electrons between the hole transporting material and the electron transporting material. The hole transporting material has a molecular structure which is prone to donate electrons in order to transport positive charges and the electron transporting material has a molecular structure which is prone to receive electrons in order to transport negative charges. Accordingly, when they are mixed in the charge transporting layer, those molecules approach each other to form a charge transfer complex since the electron transporting material receives electrons donated by the hole transporting material. The thus-formed charge transfer complex has an absorption spectrum which is different from each absorption spectrum of the hole transporting material and the electron transporting material. Generally, the absorption band of the charge transfer complex appears in a longer wavelength region as compared to absorption wavelength of the hole transporting material and the electron transporting material, and the charge transfer complex can absorb light of a longer wavelength region ranging from about 600 to about 780 nm. Thus, the electrophotographic photoreceptor according to the present general inventive concept can absorb exposure light (780 nm) emitted from a laser scanning unit that is used as an exposure device of an electrophotographic imaging apparatus or erasure light (600 nm) emitted from an eraser to generate charges in the charge transporting layer. The generated charges can remove a charge trap formed in the charge transporting layer. As a result, the laminated type electrophotographic photoreceptor according to the present general inventive concept can have excellent electrostatic properties such as high photosensitivity and low residual potential in spite of repeated use.

In particular, since the naphthalenetetracarboxylic acid diimide derivative represented by Formula 1 includes a branched alkyl group in which an aryl group is substituted to a carbon atom located at an α position with respect to the nitrogen atom of the imide bond, the derivative can have greater solubility in an organic solvent and compatibility with a polymer binder resin as compared to a conventional naphthalenetetracarboxylic acid diimide derivative in which an aromatic group, such as a substituted or unsubstituted phenyl group, is bonded to the nitrogen atom of the imide bond, and thus the charge transfer complex can be efficiently formed in the charge transporting layer.

The halogen atom in Formula 1 may be fluorine, chlorine, bromine or iodine.

The alkyl group may be a C1-C20 linear or branched alkyl group, preferably a C1-C12 linear or branched alkyl group, and more preferably a C1-C8 linear or branched alkyl group. Examples of the alkyl group include methyl, ethyl, n-propyl, isopropyl, n-butyl, isobutyl, sec-butyl, tert-butyl, pentyl, hexyl, 1,2-dimethyl-propyl, and 2-ethylhexyl. The alkyl group may be substituted with a halogen atom, such as fluorine, chlorine, bromine or iodine.

In Formula 1, the alkoxy group is a C1-C20 linear or branched alkoxy group, preferably a C1-C12 linear or branched alkoxy group, and more preferably a C1-C8 linear or branched alkoxy group. Examples of the alkoxy group include methoxy, ethoxy, and propoxy. The alkoxy group may be substituted with a halogen atom, such as fluorine, chlorine, bromine or iodine.

In formula 1, the aralkyl group is a C7-C30 linear or branched aralkyl group, preferably a C7-C15 linear or branched aralkyl group, and more preferably a C7-C12 linear or branched aralkyl group. Examples of the aralkyl group include benzyl, methylbenzyl, phenylethyl, naphthylmethyl, and naphthylethyl. The aralkyl group may be substituted with a halogen atom, such as fluorine, chlorine, bromine or iodine, an alkyl group, an alkoxy group, a nitro group, a hydroxyl group, or a sulfonic acid group.

In Formula 1, R₃ and R₄ may be each independently a group represented by formula —(CH₂)ₙ—Y—R₄. Here, Y is an oxygen atom or a sulfur atom; n is an integer from 1 to 12 and preferably from 1 to 6, and R₅ is a hydrogen atom or a C1-C20 substituted or unsubstituted alkyl group. Specific examples of the —(CH₂)ₙ—Y—R₄ group includes hydroxymethyl, hydroxyethyl, and —CH₂—S—CH₃.

The aryl group, which is indicated as Ar in Formula 1, may be a C6-C30 aromatic ring, and preferably a C6-C12 aromatic ring. Examples of the aryl group include phenyl, tolyl, xylyl, biphenyl, o-terphenyl, naphtyl, anthracenyl, and phenanthrenyl. The aryl group may be substituted with an alkyl group, an alkoxy group, a nitro group, a hydroxyl group, or a sulfonic acid group or a halogen atom.

Specific examples of the naphthalenetetracarboxylic acid diimide derivative of Formula 1 include the following compounds:

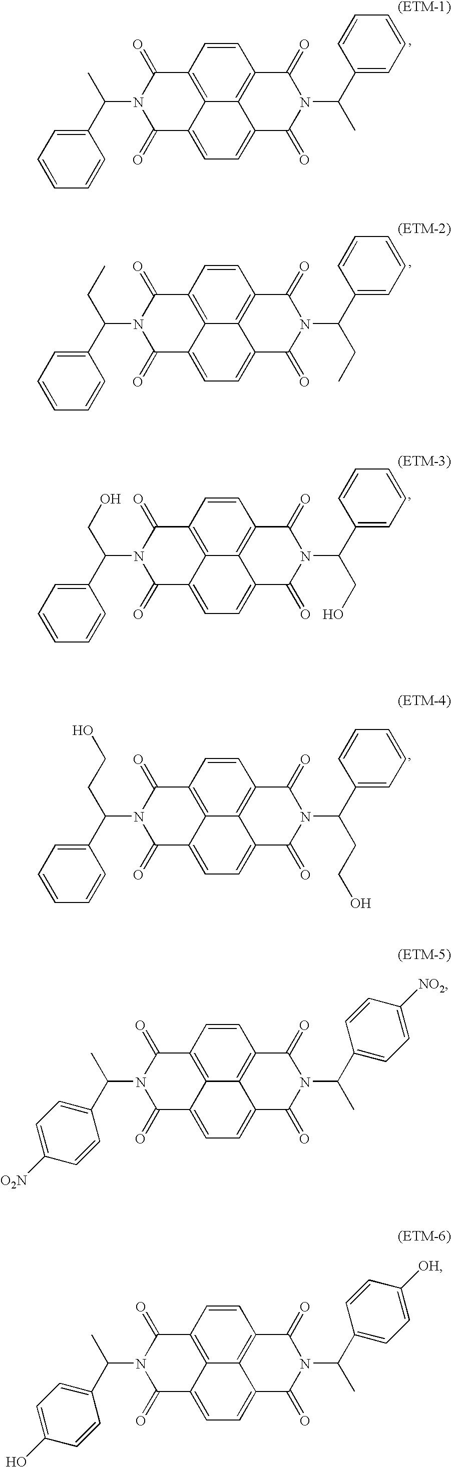

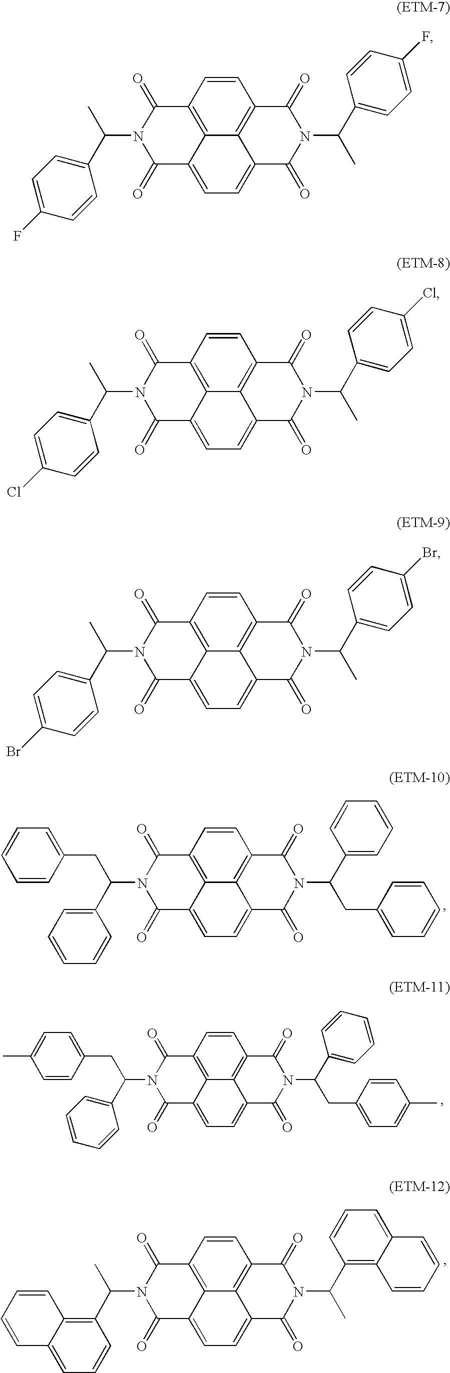

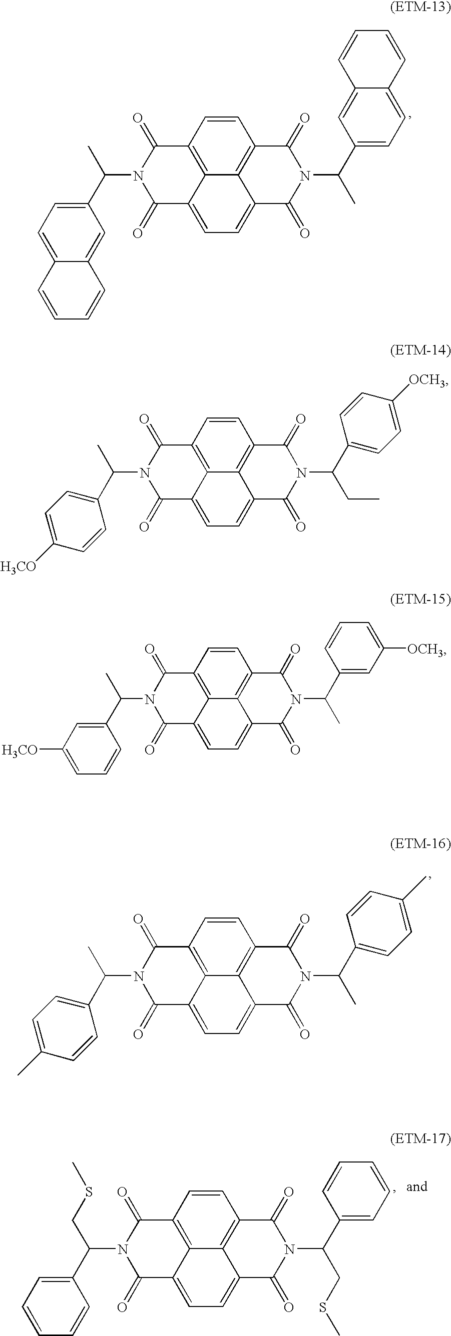

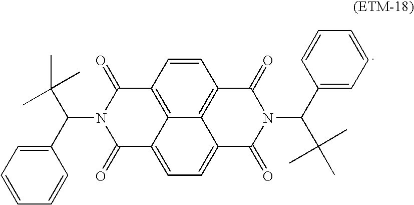

However, the present general inventive concept is not limited thereto and therefore may include similar compounds including the naphthalenetetracarboxylic acid diimide derivative of Formula 1.

The amount of the electron transporting material of Formula 1 may be in the range of about 1% to about 10% by weight, and preferably about 1% to about 5% by weight based on the weight of the hole transporting material. When the amount of the electron transporting material is less than about 1% by weight, photosensitivity cannot be sufficiently increased and residual potential cannot be sufficiently stabilized since the amount of the charge transfer complex is not sufficient in the charge transporting layer. When the amount of the electron transporting material is greater than about 10% by weight, photosensitivity can be decreased since the relative amount of the hole transporting material is reduced in the charge transporting layer.

In exemplary embodiments, the charge transporting layer may include an electron transporting material other than the electron transporting material of Formula 1 without departing from the scope of the present general inventive concept. Specifically, examples of the electron transporting material that are not represented by Formula 1 include electron attracting low-molecular weight compounds, for example, a benzoquinone-based compound, a naphthoquinone-based compound, an anthraquinone-based compound, a malononitrile-based compound, a fluorenone-based compound, a cyanoethylene-based compound, a cyanoquinodimethane-based compound, a xanthone-based compound, a phenanthraquinone-based compound, a phthalic anhydride-based compound, a dicyanofluorenone-based compound, a naphthalenetetracarboxylic acid diimide compounds which are not represented by Formula 1, a benzoquinonimine-based compound, a diphenoquinone-based compound, a stilbene quinone-based compound, a diiminoquinone-based compound, a dioxotetracenedione compound, and a thiopyran-based compound.

A composition for forming a charge transporting layer having the hole transporting material and the electron transporting material dissolved or dispersed in a binder resin is made, and the composition is coated on the charge generating layer and dried, which thereby forms a charge transporting layer. Examples of the binder resin used in the formation of the charge transport layer include, but are not limited to, an insulation resin capable of forming a film, such as polyvinyl butyral, polyarylates (condensed polymer of bisphenol A and phthalic acid, and so on), polycarbonate, a polyester resin, a phenoxy resin, polyvinyl acetate, acrylic resin, a polyacrylamide resin, a polyamide, polyvinyl pyridine, a cellulose-based resin, a urethane resin, an epoxy resin, a silicone resin, polystyrene, a polyketone, polyvinyl chloride, vinyl chloride-vinyliacetate copolymer, polyvinyl acetal, polyacrylonitrile, a phenolic resin, a melamine resin, casein, polyvinyl alcohol, and polyvinyl pyrrolidone, and an organic photoconducting polymer, such as poly N-vinyl carbazole, polyvinyl anthracene, polyvinyl pyrene, and so on.

However, in an exemplary embodiment, a polycarbonate resin is the binder resin which is to be used for forming a charge transporting layer. In particular, polycarbonate-Z derived from cyclohexylidene bisphenol is preferable to polycarbonate-A derived from bisphenol A or polycarbonate-C derived from methylbisphenol-A, because polycarbonate-Z has a high glass transition temperature and a high abrasion resistance. The amount of the binder resin used may be preferably about 5 to about 200 parts by weight, and more preferably about 10 to about 150 parts by weight, of the total weight of the hole transporting material and the electron transporting material with respect to 100 parts by weight of the binder resin.

In exemplary embodiments, the charge transporting layer may include a phosphate-based compound, a phosphine oxide-based compound, a silicone oil, and the like for increasing the abrasion resistance and providing slippage characteristics for the surface of the charge transporting layer.

In the electrophotographic photoreceptor according to the present general inventive concept, the solvent used for preparing the coating composition for forming the charge transporting layer of the electrophotographic photoreceptor may be varied according to the type of the binder resin, and may preferably be selected in such a way that it does not affect the charge generating layer formed or disposed underneath. Specifically, the solvent may be, for example, aromatic hydrocarbons such as benzene, xylene, ligroin, monochlorobenzene, and dichlorobenzene; ketones such as acetone, methyl ethyl ketone, and cyclohexanone; alcohols such as methanol, ethanol, and isopropanol; esters such as ethyl acetate and methyl cellosolve; halogenated aliphatic hydrocarbons such as carbon tetrachloride, chloroform, dichloromethane, dichloroethane, and trichloroethylene; ethers such as tetrahydrofuran, dioxane, dioxolan, ethylene glycol, and monomethyl ether; amides such as N,N-dimethyl formamide, N,N-dimethyl acetamide; and sulfoxides such as dimethyl sulfoxide. However, the present general inventive concept is not limited thereto, for example, these solvents may be used alone or in combination of two or more of the above solvents.

A method of preparing the coating composition for forming the charge transporting layer will be now described.

First, 100 parts by weight of a binder resin, about 5 to about 200 parts by weight of a mixture of a hole transporting material and an electron transporting material, and an appropriate amount of a solvent, for example about 100 to 1,500 parts by weight, and preferably about 300 to 1,200 parts by weight are mixed together and agitated.

The prepared coating composition for forming the charge transporting layer is coated on the previously formed charge generating layer. The coating methods that may be used include, for example, a dip coating method, a ring coating method, a roll coating method, and a spray coating method. The coated substrate is dried at about 90 to 200° C. for about 0.1 to about 2 hours, which thereby forms the charge transporting layer on the charge generating layer.

The thickness of the charge transporting layer may be about 2 to about 100 μm, preferably about 5 to about 50 μm, and more preferably about 10 to about 40 μm. When the thickness of the charge transporting layer is less than about 2 μm, the thickness may be too thin to provide sufficient durability. When the thickness of the charge transporting layer is greater than about 100 μm, the physical abrasion resistance may tend to increase but the printing image quality may tend to degrade.

In exemplary embodiments, the electrophotographic photoreceptor of the present general inventive concept may further include additives such as an antioxidant, an optical stabilizer, a plasticizer, a leveling agent, and a dispersion stabilizing agent in at least one of the charge transporting layer and the charge generating layer in order to increase the stability of the electrophotographic photoreceptor with respect to environmental conditions or harmful light. Examples of the antioxidant may include any known antioxidant, for example, hindered phenol-based compounds, sulfur-based compounds, esters of phosphonic acid, esters of hypophosphoric acid, and amine-based compounds, but are not limited thereto. Examples of the optical stabilizer may include any known optical stabilizer, for example, benzotriazole-based compounds, benzophenone-based compounds, and hindered amine-based compounds, but are not limited thereto. The electrophotographic photoreceptor according to an exemplary embodiment of the present general inventive concept may further include a surface protecting layer, if necessary.

The electrophotographic photoreceptor according to the present general inventive concept can be applied to electrophotographic imaging apparatuses such as laser printers, copying machines, facsimile machines and LED printers.

Hereinafter, an electrophotographic imaging apparatus employing the electrophotographic photoreceptor according to the present general inventive concept will be now described.

The electrophotographic imaging apparatus according to the present general inventive concept includes an electrophotographic photoreceptor, wherein the electrophotographic photoreceptor has a laminated structure which includes a conductive substrate and a charge generating layer and charge transporting layer formed on the conductive substrate, wherein the charge transporting layer contains a naphthalenetetracarboxylic acid diimide derivative represented by Formula 1, illustrated above.

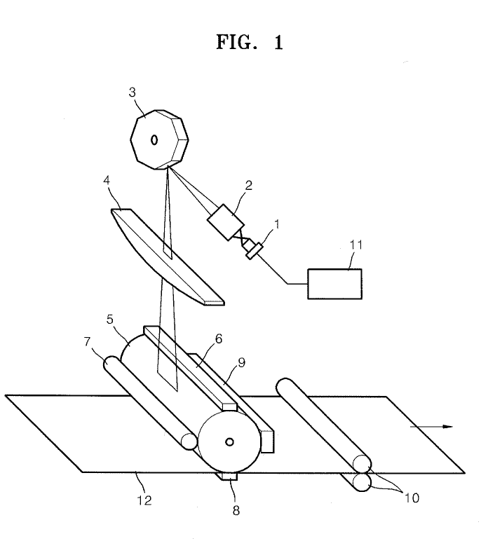

FIG. 1 is a perspective view illustrating an electrophotographic imaging apparatus according to an exemplary embodiment of the present general inventive concept.

FIG. 1 schematically illustrates an electrophotographic image forming apparatus according to an exemplary embodiment of the present general inventive concept. Referring to FIG. 1, the electrophotographic imaging apparatus according to the current exemplary embodiment of the present general inventive concept includes a semiconductor laser 1. Laser light that is signal-modulated by a control circuit 11 according to image information is collimated by an optical correction system 2 after being radiated and performs scanning while being reflected by a polygonal rotatory mirror 3. The laser light is focused on a surface of an electrophotographic photoreceptor 5 by a f-θ lens 4 and exposes the surface of the electrophotographic photoreceptor 5 according to the image information. Since the electrophotographic photoreceptor 5 may be already charged by a charging apparatus 6, an electrostatic latent image is formed by the exposure, and then becomes visible by a developing apparatus 7. The visible image is then transferred to an image receptor 12, such as paper, by a transferring apparatus 8, and is fixed in a fixing apparatus 10 and provided as a print result. The electrophotographic photoreceptor 5 can be used repeatedly by removing a coloring agent that remains on the surface thereof by a cleaning apparatus 9. The electrophotographic photoreceptor 5 according to the current exemplary embodiment of the present general inventive concept is in the form of a drum, however, the present general inventive concept is not limited thereto, and the electrophotographic photoreceptor 5 may also be in the form of a sheet or a belt, for example.

Hereinafter, the present general inventive concept will be described in further detail with reference to the following examples. However, these examples are given for the purpose of illustration and are not intended to limit the scope of the present general inventive concept.

### Example 1

20 parts by weight of titanyloxy phthalocyanine (y-TiOPc) represented by Formula 10 illustrated below as a charge generating material, 10 parts by weight of polyvinyl butyral binder resin represented by Formula 20 illustrated below (PVB 6000-C, Denka Kagaku Kogyo K. K.), 890 parts by weight of 1,2-dimethoxyethane and 80 parts by weight of cyclohexanone were sand milled for 2 hours and uniformly dispersed using ultrasonic waves. The obtained composition for a charge generating layer was coated on an anodized aluminum drum having a diameter of 30 mm using a ring bar and dried at 120° C. for 20 minutes to form a charge generating layer (CGL) having a thickness of about 0.3 μm.

20 parts by weight of arylamine-based compound represented by Formula 30 illustrated below as a hole transporting material (HTM), and 8.6 parts by weight of arylamine-based compound represented by Formula 40 illustrated below, 0.57 parts by weight of ETM-1 above as an electron transporting material, and 70 parts by weight of polycarbonate Z binder resin represented by Formula 50 illustrated below (PCZ200, Mitsubishi Gas Chemical Co. Ltd.) were dissolved in 500 parts by weight of THF/toluene cosolvent (weight ratio=3/1) to obtain a composition for a charge transporting layer. The obtained composition was coated on the charge generating layer formed on the anodized aluminum drum using a ring bar and dried at 120° C. for 30 minutes to form a charge transporting layer (CTL). The total thickness of the formed charge generating layer and the charge transporting layer was about 30 μm.

### Example 2

An electrophotographic photoreceptor drum was prepared in the same manner as in Example 1, except that ETM-2 was used instead of ETM-1.

### Example 3

20 parts by weight of y-TiOPc represented by Formula 10 illustrated below as a charge generating material, 10 parts by weight of polyvinyl butyral binder resin represented by Formula 20 illustrated below (PVB 6000-C, Denka Kagaku Kogyo K. K.), 890 parts by weight of 1,2-dimethoxyethane and 80 parts by weight of cyclohexanone were sand milled for 2 hours and uniformly dispersed using ultrasonic waves to prepare Composition 1 for a charge generating layer. 20 parts by weight of α-TiOPc represented by Formula 10 below as a charge generating material, 10 parts by weight of polyvinyl butyral binder resin (PVB 6000-C, Denka Kagaku Kogyo K. K.), 890 parts by weight of 1,2-dimethoxyethane and 80 parts by weight of cyclohexanone were sand milled for 2 hours and uniformly dispersed using ultrasonic waves to prepare Composition 2 for a charge generating layer. A composition for a charge generating layer obtained by mixing Compositions 1 and 2 in a weight ratio of 7:3 was coated on an anodized aluminum drum having a diameter of 30 mm using a ring bar and dried at 120° C. for 20 minutes to form a charge generating layer (CGL) having a thickness of about 0.3 μm.

20 parts by weight of arylamine-based compound represented by Formula 30 below as a hole transporting material (HTM), and 8.6 parts by weight of arylamine-based compound represented by Formula 40 illustrated below, 0.57 parts by weight of ETM-1 as an electron transporting material (about 1.99% by weight of the weight of the hole transporting material), and 70 parts by weight of polycarbonate Z binder resin (PCZ200, Mitsubishi Gas Chemical Co. Ltd.) were dissolved in 500 parts by weight of THF/toluene cosolvent (weight ratio=3/1) to obtain a composition for a charge transporting layer. The obtained composition was coated on the charge generating layer formed on the anodized aluminum drum using a ring bar and dried at 120° C. for 30 minutes to form a charge transporting layer (CTL). The total thickness of the formed charge generating layer and the charge transporting layer was about 30 μm.

### Example 4

An electrophotographic photoreceptor drum was prepared in the same manner as in Example 3, except that ETM-2 was used instead of ETM-1.

### Example 5

An electrophotographic photoreceptor drum was prepared in the same manner as in Example 1, except that the amount of the ETM-1 was adjusted to 1.43 parts by weight (about 5% by weight of the weight of the hole transporting material).

### Example 6

An electrophotographic photoreceptor drum was prepared in the same manner as in Example 2, except that the amount of the ETM-2 was adjusted to 1.43 parts by weight (about 5% by weight of the weight of the hole transporting material).

### Comparative Example 1

An electrophotographic photoreceptor drum was prepared in the same manner as in Example 1, except that ETM-1 was not used in the formation of the charge transporting layer.

### Comparative Example 2

An electrophotographic photoreceptor drum was prepared in the same manner as in Example 3, except that ETM-1 was not used in the formation of the charge transporting layer.

### Comparative Example 3

An electrophotographic photoreceptor drum was prepared in the same manner as in Example 1, except that the amount of the ETM-1 was adjusted to 3.15 parts by weight (about 11% by weight of the weight of the hole transporting material).

### Comparative Example 4

An electrophotographic photoreceptor drum was prepared in the same manner as in Example 2, except that the amount of the ETM-2 was adjusted to 3.15 parts by weight (about 11% by weight of the weight of the hole transporting material).

The compositions and amounts of each of the electrophotographic photoreceptors prepared according to Examples 1 through 6 and Comparative Examples 1 through 4 are summarized in Table. 1.

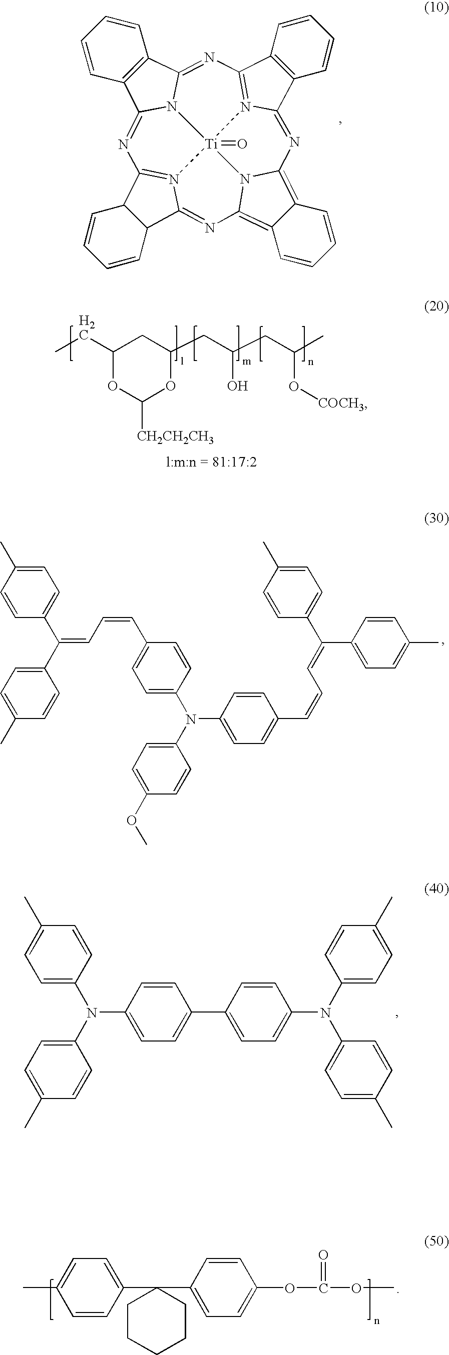

### Evaluation of Electrostatic Properties

Electrostatic properties of the electrophotographic photoreceptors prepared according to Examples 1 to 6 and Comparative Examples 1 to 4 were measured using an apparatus for estimating the electrostatic properties (“Cynthia 92”, available from Gentec Co.). The measurement conditions were as follows: (1) rotation speed of photoreceptor: 50 rpm, (2) applied voltage during charge: DC (−) 800V, (3) wavelength of light used in light exposure: monochromatic light having a wavelength of 780 nm.

According to the test results, an initial charge potential Vo_{—}0 (V), an initial residual potential Vr_{—}0 (V), a charge potential Vo_{—}1k (V) after 1000 cycles of charging and exposure to light were consecutively performed, a residual potential Vr_{—}1k (V) after 1000 cycles of charging and exposure to light were consecutively performed, an exposure energy E1/2 (μJ/cm2) which denotes exposure energy per unit area that is required in order for the surface potential of the electrophotographic photoreceptor drums to become half of the initial potential thereof as an index of the photosensitivity of the electrophotographic photoreceptor, and an exposure energy E100 which denotes exposure energy per unit area that is required in order for the surface potential of the electrophotographic photoreceptor drums to become 100 V were measured. As a result, during the measurement of the initial charge potential and the residual potential, and the charge potential and the residual potential after 1000 cycles, the exposure energy of the exposure light was 0.32 μJ/cm².

Table 1 illustrates the results of the electrostatic property test.

TABLE 1

| | | | Amount of ETM | | | | | | |
|---|---|---|---|---|---|---|---|---|---|
| | | | (wt % based on | | | | | | |
| | | | the weight of the | | | | | | |
| | | | hole transporting | E½ | E100 | Vo_0 | Vr_0 | Vo_1k | Vr_1k |
| | CGM | ETM | material) | (μJ/cm2) | (μJ/cm2) | (V) | (V) | (V) | (V) |
| Example 1 | y-TiOPc | ETM-1 | 1.99% by weight | 0.112 | 0.265 | 603 | 88 | 596 | 97 |
| Example 2 | y-TiOPc | ETM-2 | 1.99% by weight | 0.113 | 0.267 | 600 | 89 | 595 | 100 |
| Example 3 | y-TiOPc:α- | ETM-1 | 1.99% by weight | 0.126 | 0.291 | 605 | 98 | 603 | 109 |
| | TiOPc = 7:3 | | | | | | | | |
| Example 4 | y-TiOPc:α- | ETM-2 | 1.99% by weight | 0.127 | 0.293 | 602 | 96 | 601 | 106 |
| | TiOPc = 7:3 | | | | | | | | |
| Example 5 | y-TiOPc | ETM-1 | 5.0% by weight | 0.113 | 0.267 | 601 | 88 | 599 | 97 |
| Example 6 | y-TiOPc | ETM-2 | 5.0% by weight | 0.115 | 0.269 | 602 | 88 | 598 | 98 |
| Comparative | y-TiOPc | No ETM | — | 0.119 | 0.287 | 599 | 90 | 592 | 113 |
| Example 1 | | | | | | | | | |
| Comparative | y-TiOPc:α- | No ETM | — | 0.132 | 0.313 | 603 | 98 | 598 | 120 |
| Example 2 | TiOPc = 7:3 | | | | | | | | |
| Comparative | y-TiOPc | ETM-1 | 11% by weight | 0.124 | 0.303 | 602 | 94 | 593 | 111 |
| Example 3 | | | | | | | | | |
| Comparative | y-TiOPc | ETM-2 | 11% by weight | 0.128 | 0.308 | 603 | 97 | 598 | 114 |
| Example 4 | | | | | | | | | |

As shown in Table 1, the E1/2 and E100 of the electrophotographic photoreceptor drums prepared according to Examples 1 and 2 in which y-TiOPC was used as the CGM, and 1.99% by weight of each of ETM-1 and ETM-2 based on the weight of the hole transporting material was added to the CTL were far less than those of the electrophotographic photoreceptor drum prepared according to Comparative Example 1 in which ETM was not added. The residual potential after 1000 cycles Vr_{—}1k was increased by only 9 to 11 V from the initial residual potential Vr_{—}0 which indicates that the repeated use of the electrophotographic photoreceptor drum was stable.

The E1/2 and E100 of the electrophotographic photoreceptor drums prepared according to Examples 3 and 4 in which y-TiOPC and α-TiOPc were used in a weight ratio of 7:3 as the CGM, and 1.99% by weight of each of ETM-1 and ETM-2 based on the weight of the hole transporting material was added to the CTL were far less than those of the electrophotographic photoreceptor drum prepared according to Comparative Example 2 in which ETM was not added. The residual potential after 1000 cycles Vr_{—}1k was increased by only 10 to 11 V from the initial residual potential Vr_{—}0 which indicates that the repeated use of the electrophotographic photoreceptor drum was stable.

The E1/2 and E100 of the electrophotographic photoreceptor drums prepared according to Examples 5 and 6 in which y-TiOPC was used as the CGM, and 5.0% by weight of each of ETM-1 and ETM-2 based on the weight of the hole transporting material was added to the CTL were far less than those of the electrophotographic photoreceptor drum prepared according to Comparative Example 1 in which ETM was not added. The residual potential after 1000 cycles Vr_{—}1k was increased by only 8 to 10 V from the initial residual potential Vr_{—}0 which indicates that the repeated use of the electrophotographic photoreceptor drum was stable.

As discussed above, the electrophotographic photoreceptor drums prepared according to Comparative Examples 1 and 2 in which ETM was not added to the CTL had lower sensitivity as compared to the electrophotographic photoreceptor drums prepared according to Examples 1 to 4. The residual potential after 1000 cycles Vr_{—}1k was increased by 13 to 22 V from the initial residual potential Vr_{—}0 which indicates that the repeated use of the electrophotographic photoreceptor drums was unstable.

For the electrophotographic photoreceptor drums prepared according to Comparative Examples 3 and 4 in which y-TiOPC was used as the CGM and 11% by weight of each of ETM-1 and ETM-2 based on the weight of the hole transporting material was added to the CTL, the sensitivity improvement effect was saturated, and the residual potential stabilization effect was also saturated as compared to the electrophotographic photoreceptor drums prepared according to Examples 1 to 6 in which less than 10% by weight of ETM was used.

Therefore, when the amount of ETM of Formula 1 added to the CTL is less than 10% by weight, the sensitivity of the photoreceptor can be increased and the residual potential after repeated use can be stabilized.

As described above, the present general inventive concept can be efficiently applied to preparations of a laminated type electrophotographic photoreceptor having excellent electrostatic properties such as high photosensitivity and low residual potential in spite of repeated use and an electrophotographic imaging apparatus employing the laminated type electrophotographic photoreceptor.

While the present general inventive concept has been particularly shown and described with reference to a few exemplary embodiments thereof, it will be understood by those of ordinary skill in the art that various changes in form and details may be made therein without departing from the spirit and scope of the present general inventive concept as defined by the following claims and their equivalents.

What is claimed is:

1. A laminated type electrophotographic photoreceptor comprising:
an electrically conductive substrate; and
a charge generating layer and a charge transporting layer disposed on the electrically conductive substrate,
wherein the charge transporting layer comprises a naphthalenetetracarboxylic acid diimide derivative represented by Formula 1 below: 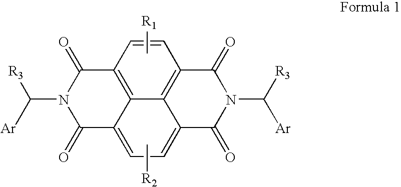
wherein R₁ and R₂ are each independently a hydrogen atom, a halogen atom, a C1-C20 substituted or unsubstituted alkyl group, or a C1-C20 substituted or unsubstituted alkoxy group;
R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12; and
Ar is a C6-C30 substituted or unsubstituted aryl group.

2. The laminated type electrophotographic photoreceptor of claim 1, wherein R₁ and R₂ are hydrogen atoms, R₃ is methyl, ethyl, propyl, butyl, pentyl, benzyl, or methylbenzyl, and Ar is phenyl, nitrophenyl, hydroxyphenyl, halophenyl, methoxyphenyl, methylphenyl, naphthyl, anthracenyl, or phenanthrenyl.

3. The laminated type electrophotographic photoreceptor of claim 1, wherein the charge transporting layer further comprises an arylamine-based compound as a hole transporting material.

4. The laminated type electrophotographic photoreceptor of claim 1, wherein the naphthalenetetracarboxylic acid diimide derivative comprised in the charge transporting layer forms a charge transfer complex with a hole transporting material and absorbs long wavelength light at about 600 to about 780 nm to generate charges in the charge transporting layer.

5. The laminated type electrophotographic photoreceptor of claim 1, wherein the naphthalenetetracarboxylic acid diimide derivative is represented by the formula below:

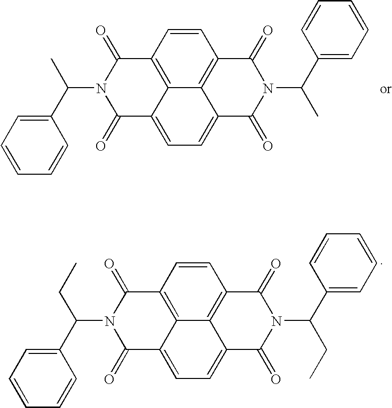

6. The laminated type electrophotographic photoreceptor of claim 1, wherein the electrically conductive substrate includes a metal, an electrically conductive polymer or a combination thereof.

7. The laminated type electrophotographic photoreceptor of claim 6, wherein the metal is selected from aluminum, vanadium, nickel, copper, zinc, palladium, indium, tin, platinum, stainless steel, chrome, or a combination thereof.

8. The laminated type electrophotographic photoreceptor of claim 1, wherein the electrically conductive polymer is a material selected from a polyester resin, a polycarbonate resin, a polyamide resin, a polyimide resin, a combination thereof and a copolymer of monomers.

9. The laminated type electrophotographic photoreceptor of claim 1, wherein an undercoat is disposed between the electrically conductive substrate and the charge generating layer or between the electrically conductive substrate and the charge transporting layer.

10. The laminated type electrophotographic photoreceptor of claim 9, wherein the undercoat includes at least a conductive powder dispersed in a binder resin or an anodized layer of Al.

11. The laminated type electrophotographic photoreceptor of claim 10, wherein the conductive powder includes a carbon black, a graphite, a metal powder, a metal oxide powder, or a combination thereof.

12. The laminated type electrophotographic photoreceptor of claim 11, wherein the metal oxide powder includes indium oxide, tin oxide, indium tin oxide, or titanium oxide.

13. An electrophotographic imaging apparatus comprising:
an electrophotographic photoreceptor comprising an electrically conductive substrate and a charge generating layer and a charge transporting layer disposed on the electrically conductive substrate, wherein the charge transporting layer comprises a naphthalenetetracarboxylic acid diimide derivative represented by Formula 1 below: 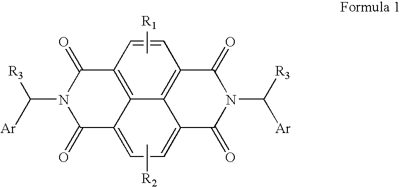
wherein R₁ and R₂ are each independently a hydrogen atom, a halogen atom, a C1-C20 substituted or unsubstituted alkyl group, or a C1-C20 substituted or unsubstituted alkoxy group;
R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12; and
Ar is a C6-C30 substituted or unsubstituted aryl group.

14. The electrophotographic imaging apparatus of claim 13, wherein R₁ and R₂ are hydrogen atoms, R₃ is methyl, ethyl, propyl, butyl, pentyl, benzyl, or methylbenzyl, and Ar is phenyl, nitrophenyl, hydroxyphenyl, halophenyl, methoxyphenyl, methylphenyl, naphthyl, anthracenyl, or phenanthrenyl.

15. The electrophotographic imaging apparatus of claim 13, wherein the charge transporting layer further comprises an arylamine-based compound as a hole transporting material.

16. The electrophotographic imaging apparatus of claim 13, wherein the naphthalenetetracarboxylic acid diimide derivative in the charge transporting layer forms a charge transfer complex with a hole transporting material and absorbs long wavelength light of about 600 to about 780 nm to generate charges in the charge transporting layer.

17. The electrophotographic imaging apparatus of claim 16, wherein the long wavelength light is derived from exposure light or erasure light.

18. The electrophotographic imaging apparatus of claim 13, wherein the naphthalenetetracarboxylic acid diimide derivative is represented by the formula below:

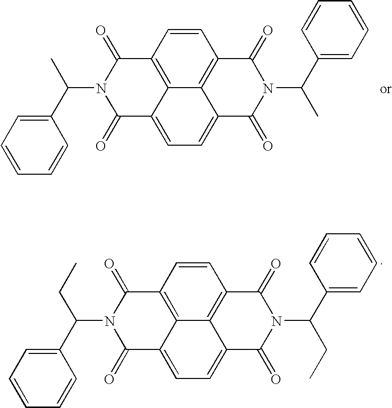

19. An electrophotographic photoreceptor comprising:
an electrically conductive substrate; and
a photosensitive layer disposed on the electrically conductive substrate,
wherein the photosensitive layer comprises a naphthalenetetracarboxylic acid diimide derivative represented by Formula 1 below: 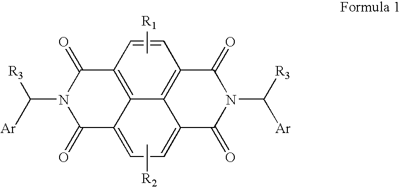
wherein R₁ and R₂ are each independently a hydrogen atom, a halogen atom, a C1-C20 substituted or unsubstituted alkyl group, or a C1-C20 substituted or unsubstituted alkoxy group;
R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12; and
Ar is a C6-C30 substituted or unsubstituted aryl group.

20. An electrophotographic imaging apparatus comprising:
an electrophotographic photoreceptor comprising an electrically conductive substrate and a photosensitive layer, wherein the photosensitive layer comprises a naphthalenetetracarboxylic acid diimide derivative represented by Formula 1 below: 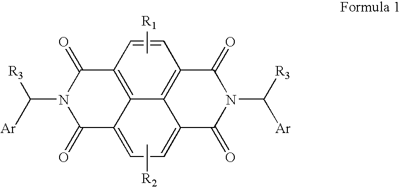
wherein R₁ and R₂ are each independently a hydrogen atom, a halogen atom, a C1-C20 substituted or unsubstituted alkyl group, or a C1-C20 substituted or unsubstituted alkoxy group;
R₃ is a C1-C20 substituted or unsubstituted alkyl group, a C1-C20 substituted or unsubstituted alkoxy group, a C7-C30 substituted or unsubstituted aralkyl group, or a —(CH₂)ₙ—Y—R₄ group, wherein Y is an oxygen atom, a sulfur atom, or NH, R₄ is a hydrogen atom, or a C1-C20 substituted or unsubstituted alkyl group, and n is an integer from 1 to 12; and
Ar is a C6-C30 substituted or unsubstituted aryl group.
